(19) United States
(12) Patent Application Publication
(10) Pub. No.: US 2004/0051987 A1
(43) Pub. Date: Mar. 18, 2004

(54) Optical substrate and method and apparatus for producing optical substrates

(76) Inventors: Stefan Bauer, Georg-Elser (DE); Markus Kuhr, Wollstein (DE); Bram Vengerling, Pohlheim-Hausen (DE); Klutz Klippe, Wiesbaden (DE); Burkhard Danielzik, Bingen (DE)

Correspondence Address: M. Robert Kestenbaum, 11011 Bermuda Dunes NE, Albuquerque, NM, 87111, US

(21) Appl. No.: 10/381,398

(22) PCT Filed: Dec. 1, 2000
(86) PCT No.: PCT/EP00/12124

(30) Foreign Application Priority Data
Sep. 29, 2000 (EP) 001215045

(51) Int. Cl. G02B 5/08; G02B 7/182

(52) U.S. Cl. 359/883

(57) ABSTRACT

To enable the time required to produce an optical substrate on which one or more layers which influence the propagation of light are to be arranged to be reduced, and preferably to provide this optical substrate with significantly lower surface stresses, the invention describes the use of an application method and an optical substrate produced using this method, in which at least one of the layers comprises halogen atoms or a halogen compound as a result of the production.

### DESCRIPTION

The invention relates in general terms to the field of optical substrates and apparatus and methods for producing them, and specifically to an optical substrate in accordance with the preamble of claim 1, a method for producing optical substrates in accordance with the preamble of claim 17 and a device for applying optical layers to a substrate for carrying out the method.

As optical signal-processing and transmission technologies start to be used at many levels, such as for example for transmission of high data rates on intercontinental or trunk lines, as well as in local networks and medium-range networks, there is an ever-growing demand for optical devices for influencing and controlling the propagation of the light which carries the information.

An important basic component of optical signal-processing and transmission technology is the optical substrate, which generally comprises a support which has been machined with a high surface quality, is itself also known as a substrate and has the minimum possible absorption when used for transmission in the wavelength range used. Generally, one or more optical layers which, depending on the particular application, range from simple reduction of reflection with just a few layers through narrow-band filters with systems which comprise more than a hundred layers, are applied to a substrate of this type. To avoid losses, these layers should present the lowest possible absorption and a high surface quality with the minimum possible number of scattering centers.

It is known to use sputtering processes, such as for example the APS process, to produce interference-optical layers which, by changing the refractive index, effect multiple-beam interference of the reflected and/or transmitted light. However, a drawback of this method is that it is often difficult to use materials which melt completely, since direct atomization of these materials in the receptacle limits possible evaporation-coating rates. Furthermore, species such as for example niobium are often no longer present in stoichiometric proportions in the applied layer, since reaction partners, such as for example oxygen, cannot be supplied in sufficient quantities on account of the low vacuum required in this method. As a result, extremely time-consuming reoxidation steps, heat treatments, are required, which have a highly adverse effect on costs. However, without reworking steps of this type, residual absorption centers often make it impossible to use these substrates. Furthermore, the process rate of the APS method in the case of case of optical multiple-beam interference substrates, for example in the case of a DWDM substrate, is so slow that it takes more than 16 hours for a batch to be processed and its quality checked. Consequently, control and adjustment procedures for optimizing the method are also extremely time-consuming.

Furthermore, a particularly drastic drawback consists in the high mechanical stresses which are produced in the surface of the substrate as a result of the layer application using the APS method. To be able to obtain any economically viable yields at all, it is necessary to use substrates with a layer thickness of more than 10 mm, and these substrates have to be machined down to their subsequent final thickness of 1 to 2 mm on the rear surface after the surface coating has been applied. This not only endangers the layer system applied but also creates further sources of interference, such as for example undesired wedge angles between the substrate surfaces.

Although the subsequently published PCT application PCT/EP 00/06518 gives an indication of the use of a plasma-induced CVD method to build up interference-optical layer systems, no details are given as to the materials which can be used and as to the mechanical and hygroscopic properties which result.

Consequently it is an object of the present invention to be able to produce optical substrates within a shorter time, the intention being that these substrates should preferably have significantly lower surface stresses. Furthermore, it is desirable for it to be possible to process a substrate having substantially the final dimensions throughout the entire sequence of the method, in order to rule out subsequent damage to the layer system and additional sources of interference right from the outset. Furthermore, it is desirable for it to be possible to use materials with a high refractive index, such as for example niobium and the associated Nb2O5 which has been introduced into the optical layer, in order to assist with designing optical layers and to promote the effectiveness of the filtering action of the optical substrates.

The object is achieved in a surprisingly simple way by an optical substrate having the features of claim 1, a production method having the features of claim 17 and a production apparatus having the features of claim 33.

Highly surprisingly, the inventors have discovered that the presence of halogen atoms or compounds in the optical layers of the substrate apparently leads to a significant reduction in surface stresses. Although hitherto the inclusion of halogen atoms or compounds in optical layers has been considered highly undesirable, since it resulted in layers of this type having a tendency to develop hygroscopic properties, so that they become less durable on account of liquid being taken up. Furthermore, it has also been assumed that this take-up of liquid, which particularly in the case of water is associated with the introduction of additional absorption bands, can be highly disadvantageous in the case of optical substrates.

However, the present invention proves that halogen atoms or compounds, provided that they remain below defined limits, are highly advantageous. It is assumed that during application of the layers halogen radicals ensure increased mobility of the species to be applied at the substrate surface or at layers which have already been applied to the substrate, which leads to the species deposited still being able to move to an energetically favorable point after it has come into contact with the surface. With regard to the layer which is to be applied, this means that it can migrate into a region which generates fewer stresses or strains in the surface.

Furthermore, similar optical layers, when there is a certain proportion of halogen atoms or compounds present, in relative terms have a higher optical density, which is attributable to the fact that vacancies which remain can be occupied more fully by the species to be applied on account of the increased surface migration.

The proportion of the halogen atoms or the halogen in the halogen compound in the layer applied to the substrate advantageously amounts to no more than 5 percent by weight, based on the material of the layer, and this proportion is particularly advantageously less than one percent by weight. Interference layers which have been applied to an optical multiple interference substrate in this way have very low mechanical stresses and therefore scarcely any stress-induced birefringence, as well as a good homogeneity and a high optical density with a low absorption.

Tantalum and niobium, which can preferably be deposited in a stoichiometric oxide ratio Nb2O5 or Ta2O5, have proven to be highly advantageous partners for the species to be deposited.

In the case of niobium, the high refractive index and the high refractive index changes which can be produced thereby in layer systems was highly advantageous for the layer design. On account of the advantages described above, it was possible to produce optical multiple interference substrates as optical cut-off filters, band-pass filters, gain-flattening filters and WDM (wavelength division multiplex) filters, in particular as DWDM (dense wavelength division multiplex) filters, quickly and with a high surface quality.

The method used to produce optical substrates of this type was preferably a PACVD (plasma assisted chemical vapor deposition) method, which in a particularly preferred embodiment was a PECVD (plasma enhanced chemical vapor deposition) method and in the most preferred embodiment was a plasma impulse CVD method, in which precursor gases with a halogen compound were used.

In this method, preferred method parameters were a pressure of from 0.05 to 10 mbar, a substrate temperature of approximately 100 to 600° C., an NbCl5 concentration of from 0.1 to 50% in the precursor gas, an HMDS (hexadimethyldisiloxane) concentration of from 0.1 to 50% in the precursor gas, a mean microwave power of from 0.01 to 20 kW and a gas flow rate of from 50 to 10,000 sccm.

A particularly preferred set of method parameters comprised a pressure of from 0.01 to 1 mbar, a substrate temperature of approximately 150 to 300° C., an NbCl5 concentration of from 0.2 to 5% in the precursor gas, an HMDSO (hexadimethyldisiloxane) concentration of from 0.25 to 15% in the precursor gas, a mean microwave power of from 0.1 to 5 kW and a gas flow rate of from 100 to 2000 sccm.

The most preferred embodiment for carrying out the method was operated at a pressure of approximately 0.2 mbar (10%, a substrate temperature of approximately 200° C. (10%, an NbCl5 concentration of approximately 2% (10% in the precursor gas, an HMDSO (hexadimethyldisiloxane) concentration of approximately 3% (10% in the precursor gas, a mean microwave power of approximately 0.5 kW (10% and with a gas flow rate of approximately 500 sccm (10%.

With the sets of parameters described above, it was possible to reduce the process speed compared to the APS method from 16 hours to less than 1.5 hours with the PICVD method, so that faster controllability and a resultant lower scrap rate became possible.

Furthermore, in a particularly advantageous way the deposition was carried out directly on substrates having substantially the final format thickness. The only change in the layer thickness consisted in the increase in thickness resulting from the deposition of the optical substrates. These substrates already had the wedge angle desired for their subsequent use and were substantially free of additional mechanical disruption.

A further advantage which is particularly important for the reproducibility of the method, in the case of the PICVD method, also consists in the fact that, on account of suitable precursor gases being supplied, there is no need to open the receptacle during the production process, as is required, for example, in the APS method in order to fill or change target materials.

The invention is described in more detail below with reference to preferred embodiments and on the basis of the appended drawings, in which:

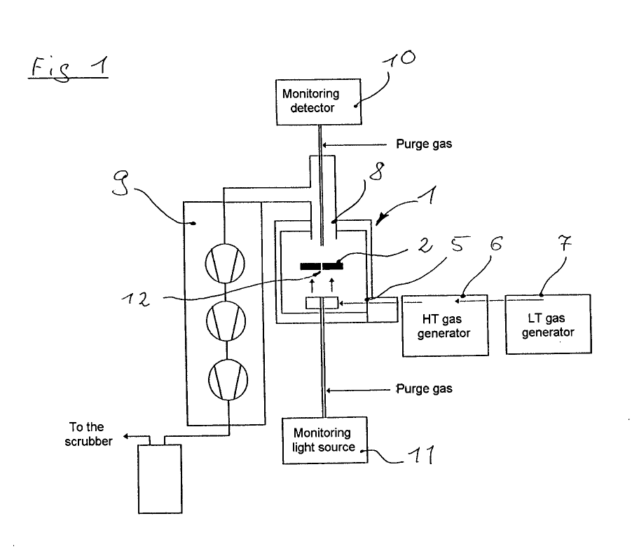

FIG. 1 diagrammatically depicts a PECVD apparatus. with its main assemblies,

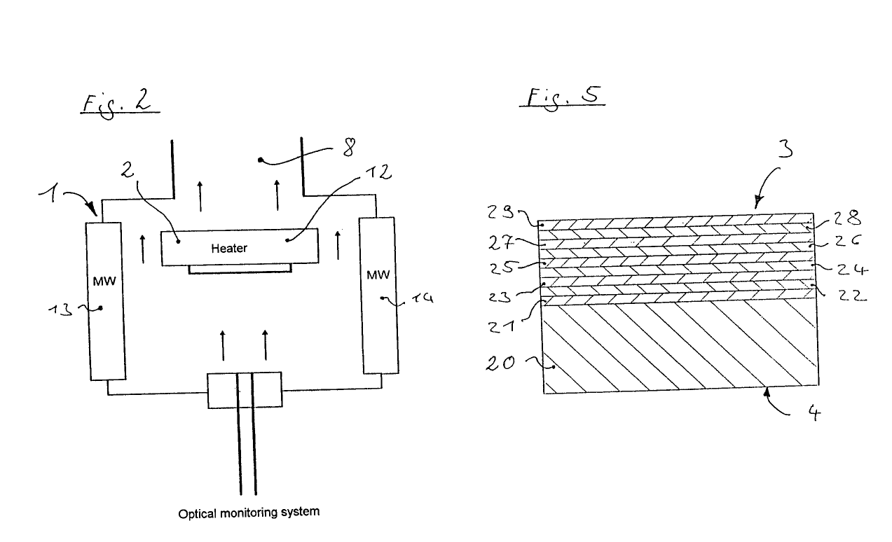

FIG. 2 shows a diagrammatically depicted excerpt from this apparatus in the region of the receptacle and the microwave generators,

FIG. 3 shows a diagrammatic side view of the receptacle, and

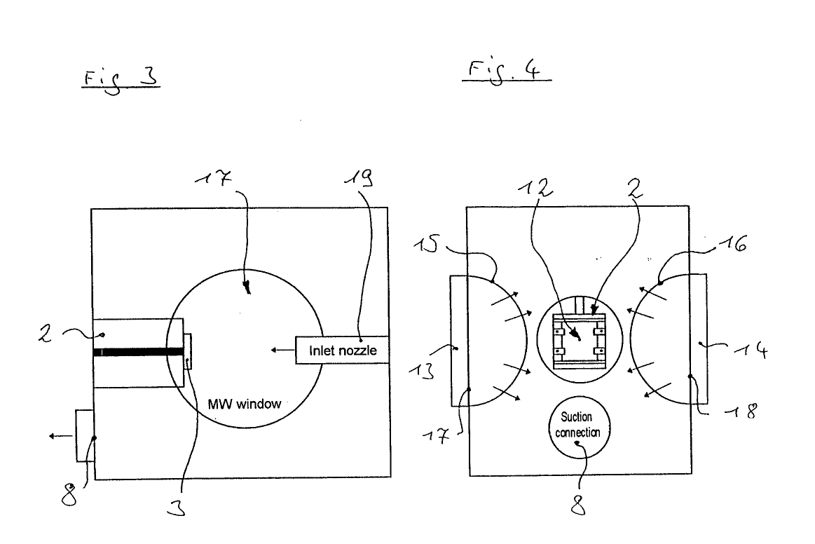

FIG. 4 diagrammatically depicts the spatial formation of the microwave plasma within the receptacle, in a front view, and

FIG. 5 shows a diagrammatic cross-sectional illustration of an optical substrate having a multiplicity of interference-optical layers.

The text which follows will first of all describe a preferred embodiment of an apparatus for applying optical layers, with reference to FIG. 1, which diagrammatically depicts the main assemblies of this apparatus.

The apparatus according to the invention comprises a receptacle in the form of an evacuable chamber 1, in which a substrate holder 2 is arranged, to which an optical substrate 3, which is illustrated in more detail in cross section in FIG. 5, can be secured by means of its rear side 4. The receptacle 1 is connected, via an inlet 5 which, in conjunction with the associated system of lines, forms a feed device for process gases, to a high-temperature (HT) gas generator 6, which in turn is fed by a low-temperature (LT) gas generator 7 and in this way feeds process precursor gases to the receptacle 1.

Furthermore, the receptacle 1 is connected, via an outlet 8 and a system of lines which form a discharge device for discharging process gases, to a pump stand 9, which comprises both pilot and main vacuum pumps, in order to be able to maintain a pressure of from 0.05 to 10 mbar stably and adjustably in the receptacle 1 even when precursor or purge gases are being supplied.

The pump stand 9 may comprise a plurality of Roots pumps or other suitable pump systems for generating the corresponding vacuum.

The gases pumped out of the receptacle 1 are passed on from the pump stand 9 to a scrubber, in order to minimize environmental pollution.

A monitoring detector 10 and a monitoring light source 11, which form an optical monitoring device, are connected to the receptacle 1 via windows which are arranged in a pressuretight manner in the housing of the receptacle 1, in such a manner that light which is emitted by the monitoring light source 11 is transmitted through the optical substrate 3 and an opening 12 in the substrate holder 2 and passes to the monitoring detector 10 which, when monochromatic light is used, with progressive layer growth on the substrate 3, records changes in the intensity of the light transmitted and in this way makes it possible to control the layer thickness growth.

The text which follows refers to FIG. 2, which shows a diagrammatically illustrated excerpt in the region of the receptacle 1 and of the microwave generators and from which it is possible to see a substrate heater 12, which either forms part of the substrate holder 2 or is arranged thereon, in such a manner that as a result it is possible to control the temperature of the substrate, and this temperature can be stabilized adjustably, preferably within a range from approximately 100 to 600° C., to a value which lies within this interval.

Microwave sources 13, 14 are arranged on either side of the substrate holder 2 and each generate their own microwave field which partially projects into the receptacle 1, as can be seen from the diagrammatic front view present in FIG. 4 by means of the lines 15 and 16 which delimit the microwave field. These lines approximately describe a field drop in the microwave field to a value below which a plasma-induced reaction can no longer be expected as a function of the other method parameters. In order, however, to enable the microwave energy to be fed into the evacuable chamber 1, the latter has lateral microwave-transmitting windows 17, 18. The diagrammatic side view shown in FIG. 3 illustrates the position of the left-hand side microwave window 17 relative to the inlet nozzle 19 of the inlet 5 and with respect to the substrate holder 2 and the optical substrate 3.

The production of an optical substrate 3 is described below with reference to preferred method sequences.

First of all, an optical substrate 4 which is of substantially its subsequent use thickness is secured to the substrate holder 2. The starting substrate generally has a base body 20 which consists of glass or quartz glass and to which the optical layers 21 to 29 of an optical layer system are applied in succession.

That surface of the substrate which is to be coated preferably has residual unevenness or roughness which, in terms of its roughness depth, is smaller than the wavelength of the radiation which is subsequently used, i.e. is preferably smaller than 1.5 or 1.0 μm. It is particularly preferred for roughness depths of this type to be less than 1/10 or 1/20 of the wavelength used and therefore to be less than 0.15 or 0.075 μm. Even smaller roughness depths can also be used and have advantages with regard to the scattering characteristics and the quality of the layers applied.

Depending on the layer design, layers which adjoin one another in each case have a different refractive index, in order in this way to produce a defined phase shift of the wave fronts and a defined reflection at the refractive index transition.

After the substrate 3 has been secured to the substrate holder 2, the receptacle is evacuated and then supplied with the process gases. According to the invention, the precursor gases used are halide-containing process gases and preferably HMDSO, hexadimethyldisiloxane, in a concentration of from 0.1 to 50%, preferably from 0.25 to 15%, and most preferably in a concentration of approximately 3% (10%.

As a result, after the process gases have been supplied, a plasma which can be ignited by microwaves is formed in the evacuable chamber 1, this plasma defining the quantitative deposition on the base body 20 in each case and formation of a layer 21 to 29 by means of the temporal duration of the microwave field and the quantity of reacting process gas supplied.

If NbCl5 is used as precursor gas, it is possible to use an NbCl5 concentration of from 0.1 to 50%, but a concentration of from 0.2 to 5% is preferred and a concentration of 2% 10% is most preferred.

The microwave power which is radiated into the evacuable chamber 1 has a usable mean power of from 0.01 to 20 kW and, in a preferred embodiment, 0.1 to 5 kW, but in the most preferred embodiment a microwave power of approximately 0.5 kW (10%.

The precursor gas flow rates can be adjusted within a range of from 50 to 10,000 sccm, and in a preferred version of the method are 100 to 2000 sccm, but in the most preferred embodiment are 500 sccm (10%.

As an alternative to chlorine, it is also possible for fluorine, bromine and/or iodine or a mixture of these halogens in suitable quantitative ratios to be used in the precursor gas.

In this case, however, the process parameters are set in such a manner that the proportion of the halogen atoms or of the halogen in the halogen compound which is applied to the substrate 20 in one of the layers 21 to 29 amounts to no more than 5 percent by weight and, in a particularly preferred embodiment, to no more than 1 percent by weight.

As an alternative to niobium, it is also possible to use tantalum. Furthermore, it is also possible, in the case of different layers, to use niobium for a first layer and tantalum for a second layer, depending on the corresponding layer design, so that in these layers niobium oxide Nb2O5 and tantalum oxide Ta2O5 are respectively formed, preferably in a stoichiometric ratio with relatively low absorption and a small number of scattering centers.

By suitable selection of the layer design of the layers 21 to 29, the number of which has been given as 9 layers in FIG. 5 purely by way of example, it is possible to produce cut-off filters, band-pass filters, gain-flattening filters and WDM (wavelength division multiplex) filters and in particular DWDM (dense wavelength division multiplex) filters with a high optical quality as the optical substrates.

Although the invention has been described on the basis of a plasma-induced CVD method, it is not restricted to this method and can advantageously be carried out using PACVD (plasma assisted chemical vapor deposition) methods and PECVD (plasma enhanced chemical vapor deposition) methods.

Furthermore, it is assumed that the incorporation of halogen atoms or halogen compounds which has been discovered to be advantageous is not restricted to the chemical deposition methods which have been presented, but rather can also be observed in other application methods.

1. An optical substrate, comprising
a substrate, on which one or more layers which influence the propagation of light are arranged,
in which at least one of the layers comprises halogen atoms or a halogen compound and a niobium- or tantalum-containing compound.

2. An optical substrate comprising a substrate, on which one or more layers which influence the propagation of light are arranged,
in which at least one of the layers comprises halogen atoms or a halogen compound, the proportion of the halogen atoms or of the halogen in the halogen compound in the layer applied to the substrate comprising no more than 1 percent by weight, based on the material of the layer.

3. The optical substrate as claimed in claim 1, wherein the halogen atoms or the halogen compound comprise halogens which are in each case selected from the group consisting of chlorine, fluorine, bromine and iodine and mixtures of chlorine, fluorine, bromine and iodine.

4. The optical substrate as claimed in one of claims 1 to 3, wherein the halogen atoms or the halogen compound are arranged in an interference layer, by which the phase-front velocity of the light transmitted through the interference layer is influenced.

5. The optical substrate as claimed in one of the preceding claims, wherein the niobium-containing compound is niobium oxide, preferably Nb₂O₅, which is arranged in an interference layer, by which the phase-front velocity of the light transmitted through the interference layer is influenced.

6. The optical substrate as claimed in one of the preceding claims, wherein the tantalum-containing compound is tantalum oxide, preferably Ta₂O₅, which is arranged in an interference layer, by which the phase-front velocity of the light transmitted through the interference layer is influenced.

7. The optical substrate as claimed in one of the preceding claims, which also includes a layer which comprises a niobium-containing compound and halogen atoms or a halogen compound.

8. The optical substrate as claimed in one of the preceding claims, which also includes a layer which comprises a tantalum-containing compound and halogen atoms or a halogen compound.

9. The optical substrate as claimed in one of the preceding claims, wherein a plurality of layers are arranged on the substrate and each have a different refractive index than at least one adjacent layer.

10. The optical substrate as claimed in claim 9, wherein the optical substrate is a multiple interference filter which acts as a cut-off filter for transmitted and/or reflected light.

11. The optical substrate as claimed in claim 9, wherein the optical substrate is a multiple interference filter which acts as a band-pass filter for transmitted or reflected light.

12. The optical substrate as claimed in claim 9, wherein the optical substrate is a multiple interference filter which acts as a gain-flattening filter.

13. The optical substrate as claimed in one of the preceding claims, wherein the optical substrate is a WDM (wavelength division multiplex) filter, in particular a DWDM (dense wavelength division multiplex) filter.

14. A method for producing optical substrates, comprising the application of a layer to a substrate, in which the layer comprises halogen atoms or a halogen compound and a niobium- or tantalum-containing compound.

15. A method for producing optical substrates, comprising the application of a layer to a substrate, in which the layer comprises halogen atoms or a halogen compound, the proportion of the halogen atoms or the halogen in the halogen compound which are applied to the substrate in the layer amounting to no more than 1 percent by weight, based on the material of the layer.

16. The method for producing an optical substrate as claimed in claim 14 or 15, wherein the halogen atoms or the halogen compound comprise halogens which are selected from the group consisting of chlorine, fluorine, bromine and iodine.

17. A method for producing an optical substrate, in particular as claimed in one of claims 14 to 16, comprising the application of a layer to a substrate which includes a niobium-containing compound.

18. The method for producing an optical substrate as claimed in claim 17, wherein the niobium-containing compound is niobium oxide, preferably Nb₂O₅, which is arranged in an interference layer, by which the phase-front velocity of the light transmitted through the interference layer is influenced.

19. A method for producing an optical substrate, in particular as claimed in one of claims 14 to 18, comprising the application of a layer which includes a tantalum-containing compound.

20. The method for producing an optical substrate as claimed in claim 19, wherein the tantalum-containing compound is tantalum oxide, preferably Ta₂O₅, which is arranged in an interference layer, by which the phase-front velocity of the light transmitted through the interference layer is influenced.

21. The method for producing an optical substrate as claimed in one of claims 14 to 20, wherein a plurality of layers are arranged on the substrate and each have a refractive index which is changed compared to at least one adjacent layer.

22. The method as claimed in one of claims 14 to 21, wherein the method is a PACVD (plasma assisted chemical vapor deposition) method.

23. The method as claimed in one of claims 14 to 22, wherein the method is a PECVD (plasma enhanced chemical vapor deposition) method, in particular a plasma impulse CVD method, in which precursor gases with a halogen compound are used.

24. The method as claimed in claim 21, 22 or 23, wherein the method is carried out at a pressure of from 0.05 to 10 mbar, a substrate temperature of approximately 100 to 600° C., an NbCl₅ concentration of from 0.1 to 50% in the precursor gas, an HMDS (hexadimethyldisiloxane) concentration of from 0.1 to 50% in the precursor gas, a mean microwave power of from 0.01 to 20 kW and with a gas flow rate of from 50 to 10,000 sccm.

25. The method as claimed in claim 21, 22 or 23, wherein the method is carried out at a pressure from 0.01 to 1 mbar, a substrate temperature of approximately 150 to 300° C., an NbCl₅ concentration of from 0.2 to 5% in the precursor gas, an HMDSO (hexadimethyldisiloxane) concentration of from 0.25 to 15% in the precursor gas, a mean microwave power of from 0.1 to 5 kW and with a gas flow rate of from 100 to 2000 sccm.

26. The method as claimed in claim 21, 22 or 23, wherein the method is carried out at a pressure of approximately 0.2 mbar ±10%, a substrate temperature of approximately 200° C.±10%, an NbCl₅ concentration of approximately 2%±10% in the precursor gas, an HMDSO (hexadimethyldisiloxane) concentration of approximately 3%±10% in the precursor gas, a mean microwave power of approximately 0.5 kW±10% and with a gas flow rate of approximately 500 sccm ±10%.

27. An apparatus for applying optical layers to a substrate, in particular for producing optical substrates as claimed in one of claims 1 to 13 and for carrying out the method as claimed in one of claims 14 to 26, comprising
an evacuable chamber (1),
a substrate holder (2) arranged in the evacuable chamber (1),
a feed device (5) for supplying process gases, in particular precursor gases for carrying out a chemical deposition
a microwave generation device (13, 14), by which a microwave field is generated at least in part of the evacuable chamber (1), and
a discharge device (8) for discharging process gases.

28. The apparatus as claimed in claim 27, wherein the apparatus is a PICVD device, in which the reaction of the process gases inside the evacuable chamber (1) can be influenced by a time-controlled microwave field.

29. The device as claimed in claim 27 or 28, which also includes an optical monitoring device (10, 11, 12), by which the layer growth on the substrate (3) can be monitored.

30. The apparatus as claimed in one of claims 27, 28 or 29, which also includes devices (6, 12) for controlling the temperature of process gases and of the substrate holder and also of the substrate.
